(19) United States
(12) Patent Application Publication
(10) Pub. No.: US 2015/0271576 A1
(43) Pub. Date: Sep. 24, 2015

(54) Apparatus and Method for Feedback System for Optical Switch Controller

(71) Applicant: FutureWei Technologies, Inc., Plano, TX (US)

(72) Inventors: Mikelis Svilans, Kanata (CA); Eric Bernier, Ottawa (CA)

(73) Assignee: FutureWei Technologies, Inc., Plano, TX (US)

(21) Appl. No.: 14/217,568

(22) Filed: Mar. 18, 2014

(51) Int. Cl. H04Q 11/00; H04B 10/2575

(52) U.S. Cl. CPC H04Q 11/0005; H04B 10/2575; H04Q 2011/0039

(57) ABSTRACT

Embodiments are provided herein for an apparatus and method for controlling an integrated photonic switching device on a photonic lightwave circuit (PLC). The apparatus includes the optical switch with a plurality of input optical signal channels and a plurality of output optical signal channels. The apparatus further includes a plurality of photodetectors that are coupled, via corresponding optical taps, to at least one of the input optical signal channels and at least one of the output optical signal channels. Additionally, a passive electrical circuit is electrically coupled to the photodetectors. The circuit is configured to generate an output electrical signal as a function of the at least one of the input optical signal channels and the at least one of the output optical signal channels. The output electrical signal has a substantially lower frequency than the input optical signal channels and the output optical signal channels.

### TECHNICAL FIELD

The present invention relates to the field of optical switches, and, in particular embodiments, to an apparatus and a method for a feedback system for an optical switch controller.

### BACKGROUND

Photonic switching devices, such as Mach-Zehnder interferometers (MZIs), fabricated using silicon wire waveguide technology are suitable as a switching fabric in ultra-small photonic lightwave circuits (PLCs). The silicon wire waveguide technology, typically applied on low-cost silicon-on-insulator (SOI) substrates, can include germanium photodetectors which are sensitive at the customary telecommunication wavelength bands, such as 1310 nm or 1550 nm bands. Optical connections and devices in the PLCs are based on a silicon core with high refractive index surrounded by a low refractive index material, typically silicon dioxide, but sometimes silicon nitride, silicon oxynitride and/or air. This structure forms an optical waveguide at telecommunications wavelengths. In the silicon PLC chip layouts, single mode and multimode waveguide elements are usually manufactured using photolithography.

Photonic switching devices that carry optical signals (at an operating bit rate) in at least two channels are controlled by electrical control settings, which have preset values to achieve the desired switching state of the device. Typically, the preset values are factory calibrated and set when the photonic switching device is made. The electrical control settings can drift or change with age or ambient operating conditions, and thus the photonic switching device may not function optimally or even within prescribed specifications. However, in many applications, for instance where these devices carry telecommunications traffic, it is not practical to remove the photonic switching device from the system for realignment or readjustment. Thus, a method is required where the electrical control settings can be realigned or optimized during normal operation.

### SUMMARY OF THE INVENTION

In accordance with an embodiment of the disclosure, an apparatus for controlling an optical switch on a photonic lightwave circuit (PLC) includes an optical switch having a plurality of input optical signal channels and a plurality of output optical signal channels, and a plurality of photodetectors coupled, via corresponding optical taps, to at least one of the input optical signal channels and at least one of the output optical signal channels. The apparatus further includes a passive electrical circuit electrically coupled to the photodetectors and configured to generate an output electrical signal as a function of the at least one of the input optical signal channels and the at least one of the output optical signal channels. The output electrical signal has a substantially lower frequency than the input optical signal channels and the output optical signal channels.

In accordance with another embodiment of the disclosure, an apparatus for controlling an optical switch on a photonic lightwave circuit (PLC) includes an optical switch having a plurality of input channels and a plurality of output channels, and a plurality of photodetectors coupled, via corresponding optical taps, to at least one of the input channels and at least one of the output channels. The apparatus further includes a circuit comprising passive electrical components electrically coupled to at least one of the plurality of photodetectors coupled to the at least one of the input channels and at least one of the output channels. The circuit is configured to generate an output electrical signal as a function of the at least one of the input channels and the at least one of the output channels. The output electrical signal has a substantially lower frequency than the input channels and the output channels. The apparatus further includes a controller electrically coupled to the circuit, and configured to adjust electrical settings for the optical switch according to the output electrical signal.

In accordance with yet another embodiment of the disclosure, a method for controlling an optical switch integrated on a photonic lightwave circuit includes tapping a portion of a first optical channel and a portion of a second optical channel of the optical switch, and converting the portion of the first optical channel into a first electrical signal proportional to the first optical channel. The method further includes converting the portion of the second optical channel into a second electrical signal proportional to the second optical channel, and generating, using an integrated passive electrical circuit, a feedback electrical signal that has a frequency substantially lower than a frequency of the first optical channel and the second optical channel. The feedback electrical signal is a function of the first electrical signal and the second electrical signal.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a typical optical switching system with feedback control;

FIG. 2 illustrates an embodiment of a system for an optical switch controller with feedback according to the current disclosure;

FIGS. 3A to 3E illustrate embodiments of integrable passive processing circuits for the optical switch controller in FIG. 2;

FIG. 4 illustrates an embodiment of a method of operation of the optical switch controller in FIG. 2; and

FIG. 5 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

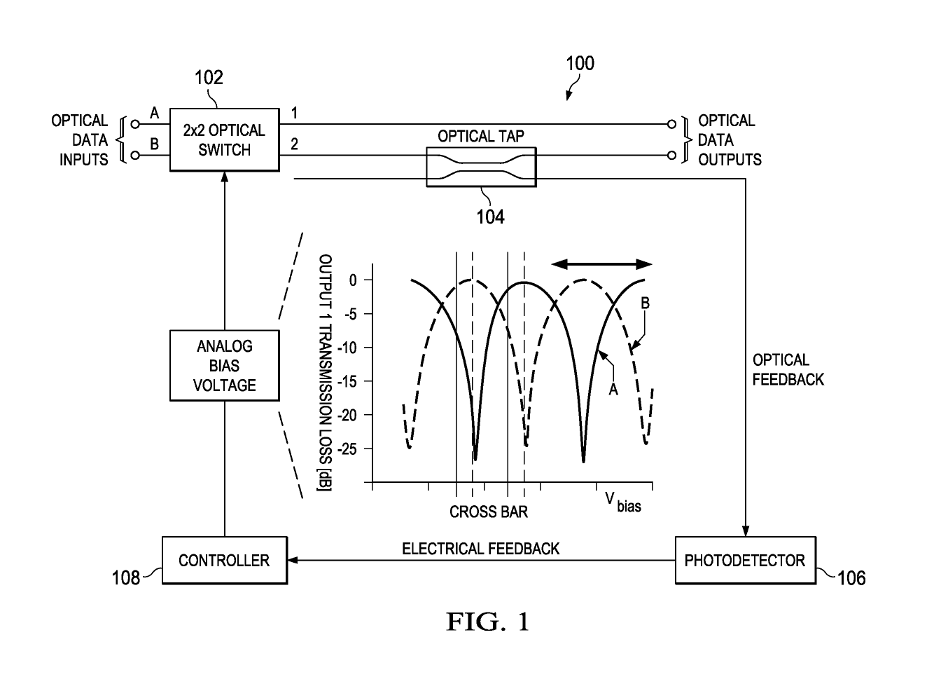

FIG. 1 shows a typical optical switching system 100 with feedback control. The system 100 includes a 2×2 optical switch 102 with two input channels, A and B. The 2×2 optical switch 102 also includes two output channels, 1 and 2. An output channel can transmit a signal from either one of the two input channels or any combination of signals from the two input channels depending on the switching state of the switch 102. An optical tap 104 is coupled to one of the output channels to send a portion of the output signal from that channel to a photodetector 106. The photodetector 106 detects the portion of the output signal and accordingly sends an electrical feedback signal to the controller 108. According to the feedback, the controller 108 adjusts the bias voltage for the 2×2 optical switch 102. For example, the controller 108 processes the feedback to identify whether it corresponds to the signal on A or B channel, and changes the bias or electrical control setting to prevent shifts in output or minimize crosstalk between A and B. An issue with such a feedback system is that optical signals are of relatively high frequency (high optical data rate), which requires high frequency electrical signal processing at the controller 108. On the other hand, it is desirable to use low frequency connections from the controller 108 to the switch 102, such as to simplify the electrical connection layout, reduce power consumption and system complexity. This requires a new design to the feedback and controller system.

Embodiments are provided herein for a system, apparatus, and method for controlling an integrated photonic switching device while it is in operation. A portion of the optical signals, in each branch at the input and output of the photonic switching device is tapped and detected by photodetectors capable of detecting the optical signals at the operating bit rate. In addition to the photonic elements, electrical elements, such as photodetectors, diodes, resistors, capacitors, and directional couplers are used. The electrical elements are integrated with the photonic elements on a photonic lightwave circuit (PLC), e.g., using available silicon wire waveguide technology. The electrical signals detected at the operating data bit rate, from two or more channels in the switching device, are correlated in an electrical circuit that outputs a resulting envelope or averaging signal at a substantially lower frequency relative to the bit rate. An envelope signal is any envelope function of the electrical signals from the two or more channels that has slower changes or smoother shape than the variations in the electrical signals. An averaging signal is any averaging function of the electrical signals from the two or more channels that has slower changes over time than the electrical signals. The low frequency provides feedback to an electrical control device for controlling the electrical control settings (bias voltage) of the photonic switching device. By dithering the electrical control settings at a suitable amplitude and frequency, the variation of the feedback signal can be used to correct an average setting (over operation time) of the electrical control settings.

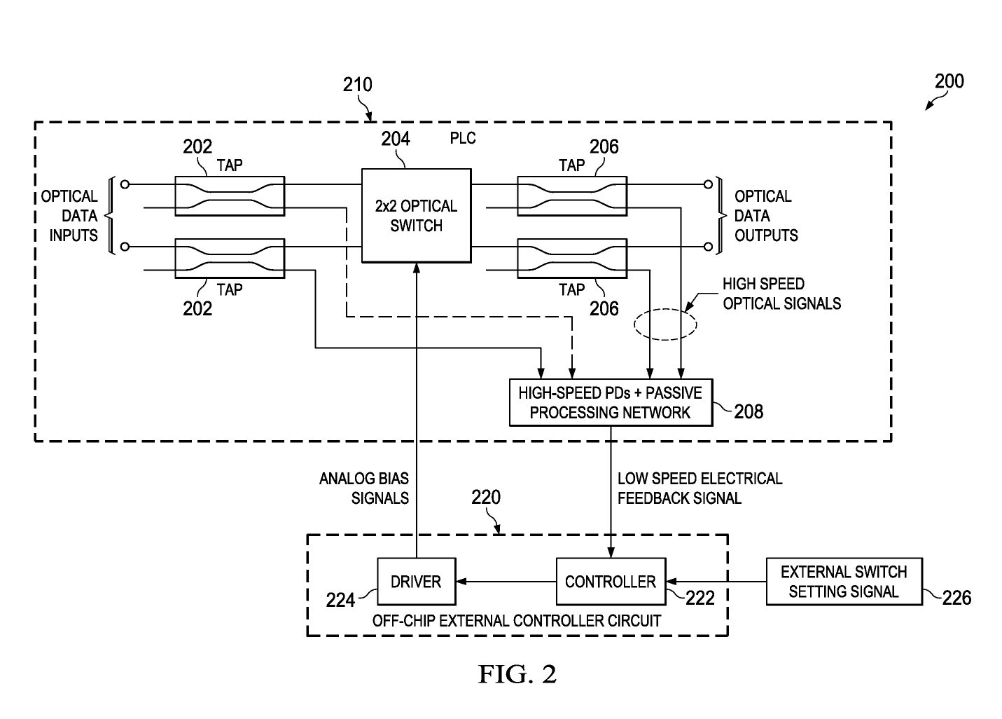

FIG. 2 shows an embodiment of a system 200 for an optical switch with feedback control. The system 200 includes a PLC 210 comprising a 2×2 optical switch 204 that has two waveguide input channels and two waveguide output channels for optical data. Examples of the 2×2 optical switch 204 include a MZI, an arrayed waveguide grating (AWG), a de/multiplexer, a multimode interference (MMI) optical waveguide, or other types of optical switching devices. At least one of the input channels is coupled to an optical input tap 202, and at least one the output channels is coupled to an optical output tap 206. The optical input tap 202 provides a portion of the corresponding input channel signal over an optical waveguide to an electrical circuit 208 integrated with the 2×2 optical switch 204 on the PLC 210. Similarly, the optical output tap 206 provides a portion of a corresponding output channel signal over an optical waveguide to the electrical circuit 208. Thus, the electrical circuit 208 receives a portion of at least one input channel signal and a portion of at least one output channel signal. The optical signals received by the electrical circuit 208 are relatively high frequency signals at the optical data rate of the 2×2 optical switch 204. For instance, the optical data rate corresponds to an optical communications system in gigahertz (GHz).

The electrical circuit 208 includes photodetectors (PDs) for receiving over an optical waveguide and detecting the received portions of the input and output channel signals. The electrical circuit 208 also includes passive electrical circuit elements, possibly with diodes, capacitors and resistors, configured to provide relatively low frequency electrical signals as feedback from the detected optical signals to a controller 222. Specifically, the electrical circuit 208 outputs an envelope or averaging electrical signal, according to the received portions of the input and output channel signals, at a substantially lower frequency than the frequency or data rate of the input/output channel signals. For example, the low frequency is in kilohertz (kHz) or megahertz (MHz). The envelope electrical signal identifies the switch state from one or more tapped input and output channel signals. For example, the envelope electrical signal is proportional to the difference between the tapped input and output channel signals.

The controller 222 uses the low frequency signal feedback from the electrical circuit 208 to determine a suitable voltage bias to the 2×2 optical switch 204, such as to maximize throughput and minimize crosstalk. According to the feedback, the controller 222 adjusts the electrical control settings (or voltage bias) to a driver 224 that drives the 2×2 optical switch 204. For example, the voltage bias is changed on the 2×2 optical switch 204 to cause an index change and hence a phase change between the two arms within a Mach-Zehnder interferometer, adjusting device operation and output. The controller 222 and the driver 224 can be integrated on an off-chip (off-PLC) external controller circuit 220.

In other embodiments, the PLC 210 may include multiple 2×2 optical switches 204 and/or other types of switches, with respective electrical circuit 208 or corresponding PDs and passive electrical elements in the electrical circuit 208. For each of the switches 204, at least one input channel signal and one output channel signal are tapped and detected by the electrical circuit(s) 208. The electrical circuit(s) 208 provide(s) correlated, low frequency envelope or averaging electrical signals, according to the corresponding tapped input and output channel signals, to the controller 222. The low frequency electrical signals are fed to the controller 222, which in turn adjusts accordingly the electrical control settings for the corresponding multiple 2×2 optical switches 204, via one or more drivers 224, at equivalent low frequency.

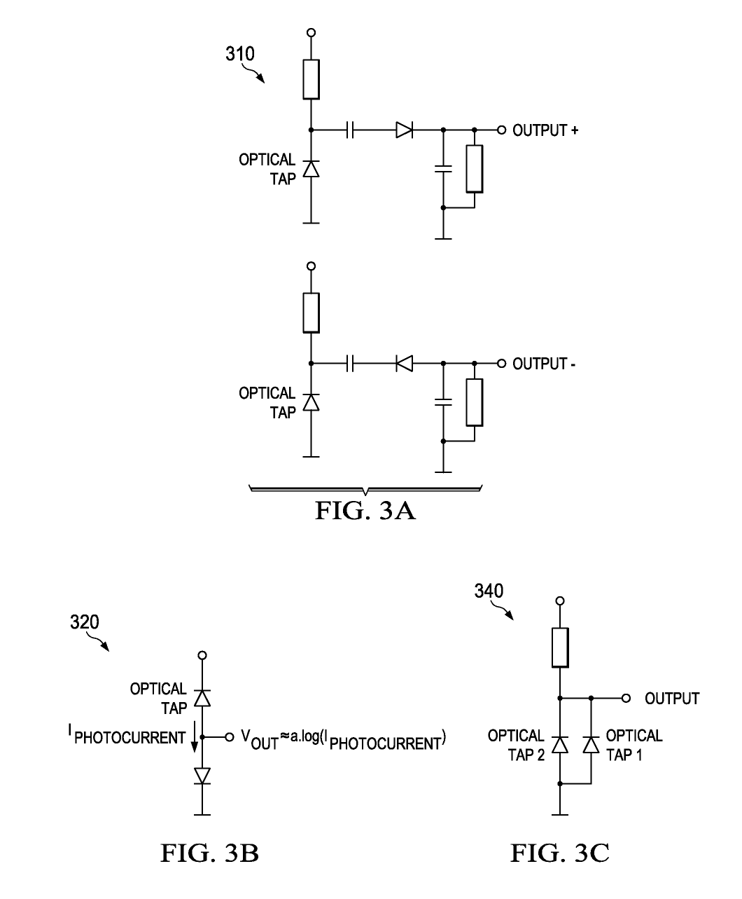

In embodiments, the envelope electrical signal generated by the electrical circuit 208 includes at least one of or any combination of the following functions: signal correlation between input and output channels, envelope detection of input and output channels, signal ratio between input and output channels, addition of input and output channels, difference between input and output channel, and low-pass filter of input and output channels. FIGS. 3A to 3E show embodiments of integrable passive processing circuits for an optical switch controller. At least one of or any of the embodiment circuits can be used as part of the electrical circuit 208, in combination with PDs, to generate the envelope or averaging electrical signal at relatively low frequency as feedback to the controller 222. The passive circuits can include an envelope detection circuit 310 that can output either a positive envelope output or a negative envelope output, depending on the polarity of the electrical diode. The circuits can include a circuit 320 that outputs a voltage proportional to the logarithm (or equivalently on a dB scale) of the photocurrent generated by a tapped channel in a PD. The circuits can include a low pass filter circuit 330 for tapping a channel. The circuits can include a fast photocurrent sum circuit 340 for tapping two channels. The circuits can also include a fast photocurrent difference circuit 350 for tapping two channels. Other circuits that comprise similar components and provide an averaging function (over operation time) of signals on input and output channels can also be applied.

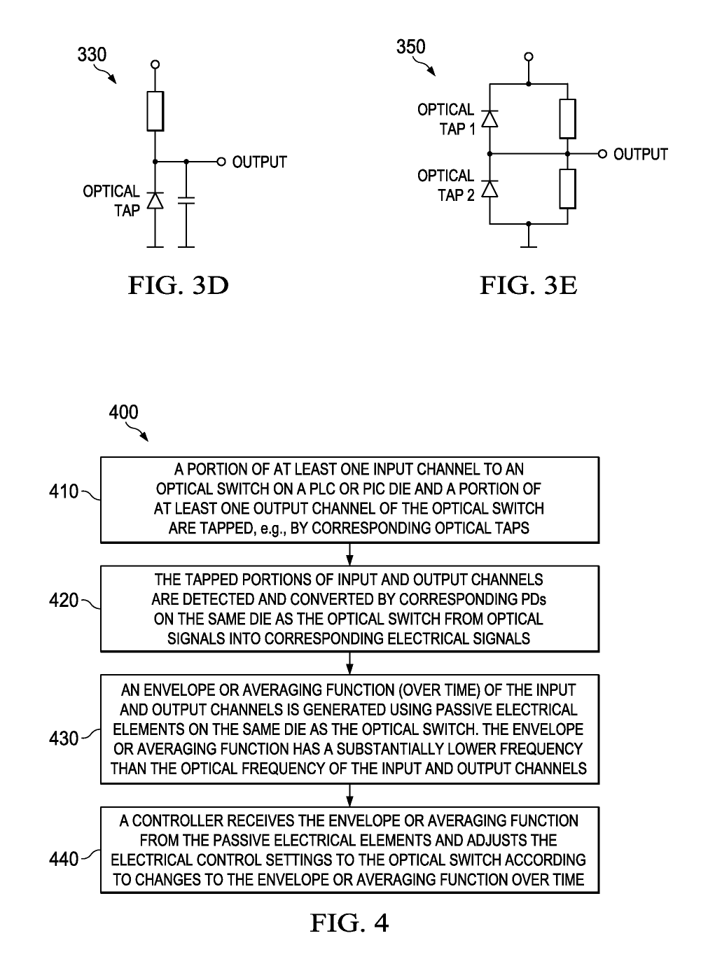

FIG. 4 shows an embodiment of a method 400 of operation of an optical switch controller. At step 410, a portion of at least one input channel to an optical switch (e.g., 2×2 optical switch) on a PLC or PIC die and a portion of at least one output channel of the optical switch are tapped, e.g., by corresponding optical taps. At step 420, the tapped portions of input and output channels are detected and converted by corresponding PDs on the same die as the optical switch from optical signals into corresponding electrical signals. At step 430, an envelope or averaging function (over time) of the input and output channels is generated using passive electrical elements on the same die as the optical switch. This can be achieved using any combinations of the embodiment electrical circuits above. Specifically, the envelope or averaging function has a substantially lower frequency than the optical frequency of the input and output channels. At step 440, a controller receives the envelope or averaging function from the passive electrical elements and adjusts the electrical control settings to the optical switch according to changes to the envelope or averaging function over time.

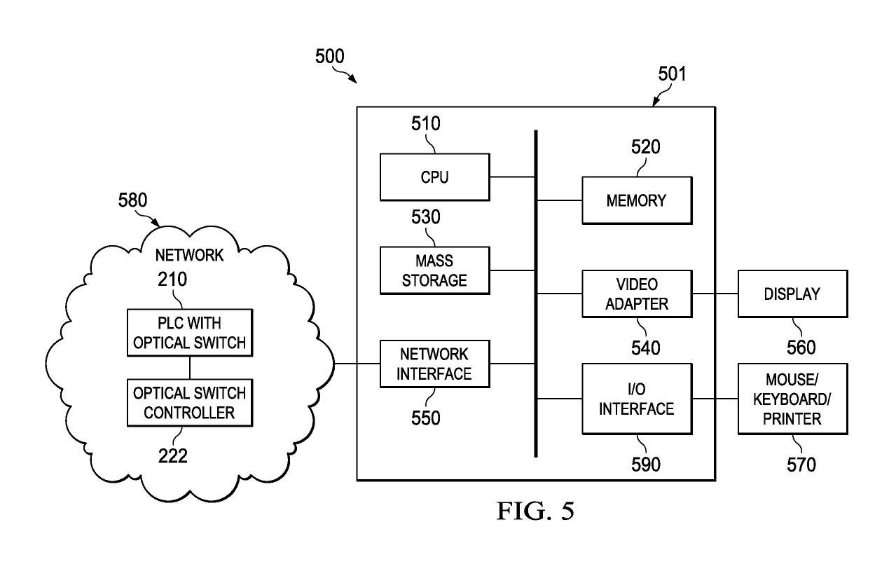

FIG. 5 is a block diagram of an exemplary processing system 500 that can be used to implement various embodiments. The processing system can comprise the controller or feedback system described above or be part of a network component (e.g., a network router, switch or other transmitting component) comprising or coupled to the optical switch system described above. The processing system 500 may comprise a processing unit 501 equipped with one or more input/output devices, such as a speaker, microphone, mouse, touchscreen, keypad, keyboard, printer, display, and the like. The processing unit 501 may include a central processing unit (CPU) 510, a memory 520, a mass storage device 530, a video adapter 540, and an Input/Output (I/O) interface 590 connected to a bus. The bus may be one or more of any type of several bus architectures including a memory bus or memory controller, a peripheral bus, a video bus, or the like.

The CPU 510 may comprise any type of electronic data processor. The memory 520 may comprise any type of system memory such as static random access memory (SRAM), dynamic random access memory (DRAM), synchronous DRAM (SDRAM), read-only memory (ROM), a combination thereof, or the like. In an embodiment, the memory 520 may include ROM for use at boot-up, and DRAM for program and data storage for use while executing programs. The mass storage device 530 may comprise any type of storage device configured to store data, programs, and other information and to make the data, programs, and other information accessible via the bus. The mass storage device 530 may comprise, for example, one or more of a solid state drive, hard disk drive, a magnetic disk drive, an optical disk drive, or the like.

The video adapter 540 and the I/O interface 590 provide interfaces to couple external input and output devices to the processing unit. As illustrated, examples of input and output devices include a display 560 coupled to the video adapter 540 and any combination of mouse/keyboard/printer 570 coupled to the I/O interface 590. Other devices may be coupled to the processing unit 501, and additional or fewer interface cards may be utilized. For example, a serial interface card (not shown) may be used to provide a serial interface for a printer.

The processing unit 501 also includes one or more network interfaces 550, which may comprise wired links, such as an Ethernet cable or the like, and/or wireless links to access nodes or one or more networks 580. The network(s) 580 may include the PLC 210 with the optical switch, and the controller 222, for example at one or more network locations. The network interface 550 allows the processing unit 501 to communicate with these remote units via the networks 580. In an embodiment, the processing unit 501 is coupled to a local-area network or a wide-area network for data processing and communications with remote devices, such as the PLC 210 with the optical switch, and the controller 222, other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus for controlling an optical switch on a photonic lightwave circuit (PLC), the apparatus comprising:
an optical switch having a plurality of input optical signal channels and a plurality of output optical signal channels;
a plurality of photodetectors coupled, via corresponding optical taps, to at least one of the input optical signal channels and at least one of the output optical signal channels; and
a passive electrical circuit electrically coupled to the photodetectors and configured to generate an output electrical signal as a function of the at least one of the input optical signal channels and the at least one of the output optical signal channels, wherein the output electrical signal has a substantially lower frequency than the input optical signal channels and the output optical signal channels.

2. The apparatus of claim 1, wherein the optical switch and the passive electrical circuit are integrated on the PLC, the optical switch being connected by waveguides to the photodetectors via optical taps.

3. The apparatus of claim 1, wherein the passive electrical circuit comprises one or more electrical circuit components including at least one of a capacitor, a resistor and a diode.

4. The apparatus of claim 1, wherein the passive electrical circuit includes an envelope detection circuit comprising a plurality of resistors and a plurality of capacitors, and electrically connected to receive an electrical input signal from at least one of the photodetectors disposed for tapping optical signal channels of the optical switch.

5. The apparatus of claim 1, wherein the passive electrical circuit includes a logarithmic output circuit comprising at least one of a plurality of resistors, a plurality of diodes and a plurality of capacitors electrically connected to receive an electrical input signal from at least one of the photodetectors disposed for tapping at least one of the optical signal channels of the optical switch.

6. The apparatus of claim 1, wherein the passive electrical circuit comprises at least one of a plurality of resistors and a plurality of capacitors in a low-pass filter configuration, and electrically connected to receive an electrical input signal from at least one of the photodetectors disposed for tapping one channel of the optical switch.

7. The apparatus of claim 1, wherein the passive electrical circuit includes a fast photocurrent sum circuit electrically connected to receive an electrical input signal from at least two of the photodetectors disposed for tapping two channels of the optical switch.

8. The apparatus of claim 1, wherein the passive electrical circuit includes a fast photocurrent difference circuit eclectically connected to receive an electrical input signal from at least two of the photodetectors disposed for tapping two channels of the optical switch.

9. The apparatus of claim 1 further comprising:
a controller electrically coupled to the passive electrical circuit and configured to adjust electrical settings for the optical switch according to the output electrical signal; and
a driver electrically coupled to the controller and the optical switch and configured to apply voltage bias to the optical switch according to the electrical settings.

10. An apparatus for controlling an optical switch on a photonic lightwave circuit (PLC), the apparatus comprising:
an optical switch having a plurality of input channels and a plurality of output channels;
a plurality of photodetectors coupled, via corresponding optical taps, to at least one of the input channels and at least one of the output channels;
a circuit comprising passive electrical components electrically coupled to at least one of the plurality of photodetectors coupled to the at least one of the input channels and at least one of the plurality of photodetectors corresponding to the output channels, wherein the circuit is configured to generate an output electrical signal as a function of the at least one of the input channels and the at least one of the output channels, and wherein the output electrical signal has a substantially lower frequency than the input channels and the output channels; and
a controller electrically coupled to the circuit, and configured to adjust electrical settings for the optical switch according to the output electrical signal.

11. The apparatus of claim 10, wherein the optical switch and the circuit are integrated on the PLC, and wherein the controller is external to the PLC.

12. The apparatus of claim 10, wherein the optical switch is a communications device for optical communications that operates in a gigahertz (GHz) frequency range, and wherein the output electrical signal has a frequency in a range from kilohertz (kHz) to megahertz (MHz).

13. A method for controlling an optical switch integrated on a photonic lightwave circuit, the method comprising:
tapping a portion of a first optical channel and a portion of a second optical channel of the optical switch;
converting the portion of the first optical channel into a first electrical signal proportional to the first optical channel;
converting the portion of the second optical channel into a second electrical signal proportional to the second optical channel; and
generating, using an integrated passive electrical circuit, a feedback electrical signal that has a frequency substantially lower than a frequency of the first optical channel and the second optical channel, wherein the feedback electrical signal is a function of the first electrical signal and the second electrical signal.

14. The method of claim 13 further comprising sending the feedback electrical signal to a controller for controlling electrical settings for the optical switch.

15. The method of claim 13 further comprising adjusting electrical settings for the optical switch according to the feedback electrical signal, wherein the electrical settings determine operation and output of the optical switch.

16. The method of claim 13, wherein the first optical channel is an input channel to the optical switch, and wherein the second optical channel is an output channel from the optical switch.

17. The method of claim 13, wherein the feedback electrical signal is an envelope function of the first electrical signal and the second electrical signal and changes over time at a slower rate than the first electrical signal and the second electrical signal.

18. The method of claim 13, wherein the feedback electrical signal is an averaging function of the first electrical signal and the second electrical signal and changes over time at a slower rate than the first electrical signal and the second electrical signal.

19. The method of claim 13, wherein the feedback electrical signal is a correlation function between the first electrical signal and the second electrical signal.

20. The method of claim 13, wherein the feedback electrical signal is an addition of the first electrical signal and the second electrical signal.

21. The method of claim 13, wherein the feedback electrical signal is a difference between the first electrical signal and the second electrical signal.

22. The method of claim 13, wherein the feedback electrical signal is a a ratio of the first electrical signal and the second electrical signal.

23. The method of claim 13, wherein the feedback electrical signal is a low-pass filter function of the first electrical signal and the second electrical signal.
